(19) United States
(12) Patent Application Publication
(10) Pub. No.: US 2003/0100219 A1
(43) Pub. Date: May 29, 2003

(54) Binding post marker

(76) Inventor: James E. Dickens, Ocoee, FL (US)

Correspondence Address: KIRKPATRICK & LOCKHART LLP, 535 SMITHFIELD STREET, PITTSBURGH, PA, 15222, US

(21) Appl. No.: 09/994,300

(22) Filed: Nov. 26, 2001

(51) Int. Cl. H01R 3/00

(52) U.S. Cl. 439/491

(57) ABSTRACT

A binding post marker comprising at least two joinable tubes that are sized to fit respectively over a corresponding number of binding posts in a cross-connect board.

### BACKGROUND OF THE INVENTION

1. Field of the Invention

The invention relates a device that marks binding posts and, in particular, to a device that marks pairs of binding posts in a cross-connect box.

2. Description of the Invention Background

A telephone distribution system generally includes a main central office that houses switching and other equipment which interfaces with cables that provide telephone service to the office's subscribers. To provide an efficient and flexible connection, the subscribers are typically grouped geographically in areas that are serviced by a local central office. A feeder cable, generally known as “primary” or “facility one” (F1) cable, connects the local central office to a cross-connect box. Secondary cables, or “facility two” (F2) cables, lead from the cross-connect box to the individual subscribers.

Each of the primary and secondary cables typically carries thousands of conductors that come in pairs of wires known as a tip wire and a ring wire. The tip and ring wires of each pair are connected to respective pairs of binding posts, which serve to provide convenient connection between the primary and secondary cables. Thus, a typical cross-connect box includes a multitude of pairs of binding posts that serve as cross connects for the myriad of conductors in the primary and secondary cables. Furthermore, to effect a connection from the local central office to an individual subscriber, a free or open pair of binding posts from F1 must be connected to a pair of F2 binding posts for that subscriber.

A time-consuming task for a servicing technician is to identify an open pair for connection, or a pair that needs repair, or to simply note a particular condition for future work, such as “grounded”, “open”, etc. Currently, defective conditions are identified for future repair by attaching a cloth or paper tag that has the word “defective” or other appropriate message written on it. Such tags are often damaged, lost or removed. It will be appreciated that such tags are ill-suited to be re-used, and even when they are originally used, they can cause hindrance and inconvenience because they obstruct some of the work area. Moreover, such paper or cloth tags become dirty or torn and often create a mess in the technician's tool bag or holder. As a result, technicians are not motivated to use such tags, and the savings in time and effort that would be associated with proper marking of defective binding posts are thus lost.

There remains, therefore, a need for a marker that can be easily installed on binding posts to notify the technician of their present condition without the shortcomings associated with other marking arrangements.

### BRIEF DESCRIPTION OF THE DRAWINGS

In the accompanying Figures, there are shown present embodiments of the invention wherein like reference numerals are employed to designate like parts and wherein:

FIG. 1 is a partial plan view of a cross-connect box showing a first embodiment of a binding post marker according to the present invention installed on a pair of binding posts;

FIG. 2 is an isometric view of the binding post marker of FIG. 1;

FIG. 3 is a front view of the binding post marker of FIG. 1;

FIG. 4 is a bottom view of the binding post marker of FIG. 1;

FIG. 5 is a top view of another embodiment of a binding post marker of the present invention;

FIG. 6 is a front view of the binding post marker of FIG. 5;

FIG. 7 is a partial plan view showing an arrangement of three binding post markers of an embodiment of the present invention in a cross-connect box;

FIG. 8 is a bottom view of a another embodiment of a binding post marker according to the present invention;

FIG. 9 is a bottom view of another embodiment of a binding post marker according to the present invention;

FIG. 10 is an isometric schematic view of a substrate having elongate elements showing another embodiment of a marker according to the present invention;

FIG. 11 is a sectional view of a partially assembled embodiment of a binding post marker according to the present invention;

FIG. 12 is a sectional view of another partially assembled embodiment of a binding post marker according to the present invention; and

FIG. 13 is a sectional view of another partially assembled embodiment of a binding post marker according to the present invention.

### DETAILED DESCRIPTION OF THE INVENTION

Referring now to the drawings for the purpose of illustrating the invention and not for the purpose of limiting the same, it is to be understood that standard components or features that are within the purview of an artisan of ordinary skill and do not contribute to the understanding of the various embodiments of the invention are omitted from the drawings to enhance clarity. In addition, it will be appreciated that the characterizations of various components and orientations described herein as being “vertical” or “horizontal” or “top” or “bottom” or in rows or columns, are relative characterizations only based upon the particular position or orientation of a given component for a particular application.

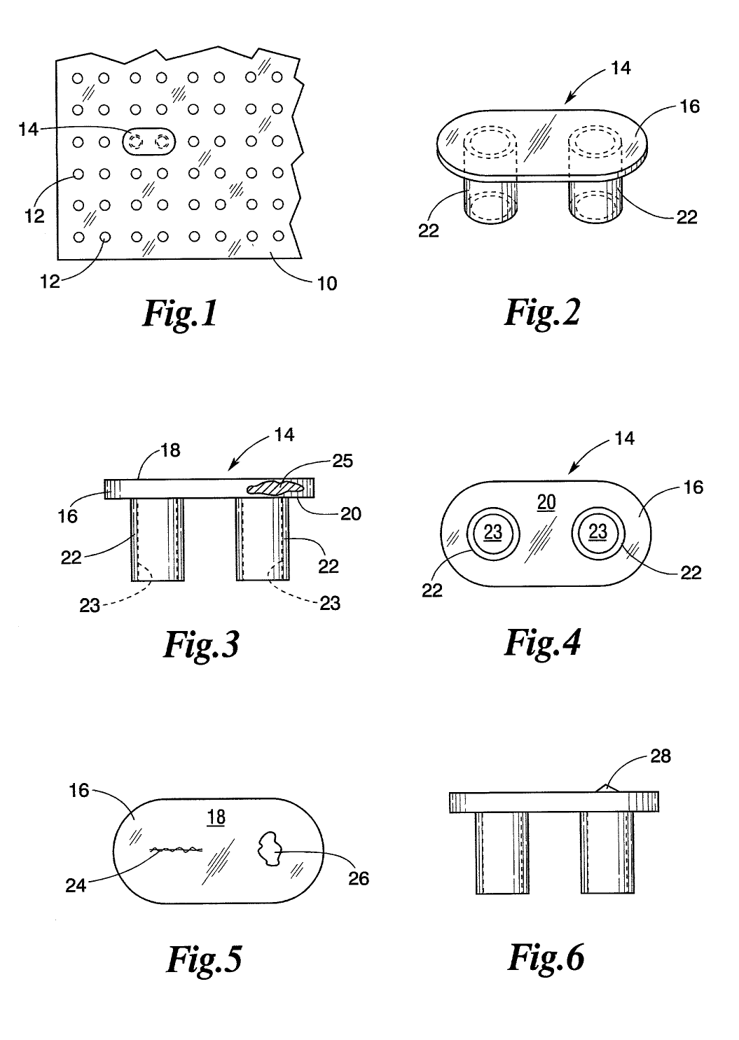

FIG. 1 depicts a portion of a cross-connect board 10 having a plurality of binding posts 12 that protrude outward therefrom. In a typical cross-connect box, the binding posts 12 are arranged in pairs that generally correspond to pairs of tip and ring wires (not shown) and form an array of rows and/or columns. A binding post marker 14 of one embodiment of the present invention is attached to a pair of binding posts 12 and, as will be discussed in further detail below, can convey a message concerning those particular binding posts and/or the wires attached thereto.

As shown in FIGS. 2-4, in this embodiment, the marker 14 includes a flange 16 having a top surface 18 and a bottom surface 20. Two legs 22 protrude from the bottom surface 20 of the flange 16. The legs 22 each have a post-receiving hole 23 that are each sized to receive a corresponding binding post 12 therein. The marker 14 is inserted onto the corresponding binding posts 12 by aligning the holes 23 with the posts 12 and applying a force to the flange 16 to cause the legs 22 to slide onto the posts 12.

It will be understood that the hole 23 may be sized to create a slight interference or frictional fit with the binding post 12 to retain the marker 14 thereon. For example, an interference of approximately 0.4 inches (1 mm) may be provided between the post 12 and the hole 23, which will enable the legs 22 to be inserted under an amount of pressure generated by pushing the flange 16 with one's thumb toward the cross connect board 10 and may be removed from the posts 12 by grasping the flange 16 and puling it away from the cross-connect board 10 or by using a small hand tool such as a screw driver or the like to carefully pry it off the binding posts 12.

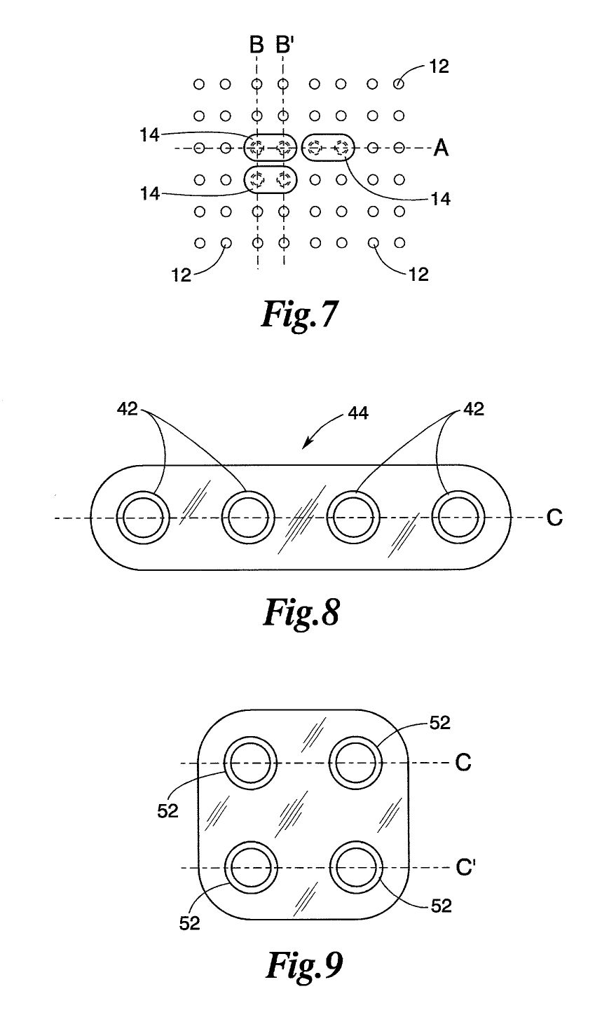

The flange 16 may be sized so that two markers 14 may be fitted over two pairs of binding post 12, when the four binding posts 12 are aligned along a row A, or along two columns B and B′, as shown in FIG. 7.

The marker 14 may be constructed from a variety of materials, such as, for example, from plastic or other polymeric or non-conductive material by injection molding or other appropriate conventional methods. The material of the marker 14 may have characteristics that permit it to withstand outdoor weather conditions without cracking or losing its ability to flex and either snap on or fit snugly over the binding posts 12. The legs 22 may be provided with snap on clips (not shown) or may be made of material that deforms elastically to a sufficient degree (i.e. an elastic material of appropriate stress-strain relation) to allow the insertion of the binding posts 12 and retain the legs 22 on the posts 12 by its tendency to return to its original undeformed state and/or by a frictional fit.

The top surface 18 of the marker may be provided with a superficial 24 or structural 26 identification mark or other desirable indicia. Either mark 24 or 26 may be literal or symbolic. For example, a literal mark may include a writing with abbreviations of the words open, ground, short, open ring, open tip, quick serve, etc to indicate respective conditions of the marked binding posts 12. Thus OPN-R may be used to denote that the ring wire is open, QSRV may be used to denote readiness for connection (quick serve), GRND groundedness, etc. A literal superficial mark 24 would comprise a flat inscription, while a literal structural mark would comprise an embossed inscription. A symbolic mark, on the other hand, may use a symbol to denote the conditions of openness, groundedness, etc., either as a superficial mark 24 or as an embossed (structural) mark 26. The embossed mark 26 may comprise one or more structural asperities or depressions, generally indicated as 28 in FIG. 6. A symbolic mark may comprise international or locally used symbols for such marking.

Furthermore, it is conceivable that the marker may be fabricated to have a predetermined color or colors 25 that have a certain understood meaning to an installer. (See FIG. 3). For example, a red marker 14 may connote a grounded circuit, a green marker may connote an open circuit, etc.

An alternative binding post marker embodiment 44, shown in FIG. 8 may include four legs 42 arranged in one row C to identify two consecutive pairs of binding posts. Another binding post marker embodiment 54 may include four legs 52 arranged in two rows C, C′ as shown in FIG. 9. Such embodiments are essentially identical to the above-mentioned marker 14, except for the number of legs and the size of the corresponding flange. It will be further understood that the marker 14 could be fabricated with an appropriate number of legs to mark an entire block or segment.

FIGS. 11-13 illustrate an embodiment 70 of the binding post marker of the invention in which the flange 76 is detachable from the legs 22. Both the flange 76 and the legs 22 may be interchangeable. When the condition of the binding posts changes, the previous flange 76 may be removed and a flange 76 with appropriate marking or color to indicate the current condition may be attached. Similarly, the legs may be interchangeable with legs of the same of different color. The flange 76 may be removably attached to the legs with any conventional means, such as, for example, recesses 77 that receive the legs 72, as shown in FIG. 11, or protuberances 79, received in the holes 73 of the legs, as shown in FIG. 12, or clips 75 and the like that snap on the legs 72 as shown in FIG. 13.

It will appreciated from the above description that the various binding post marker embodiments of the present invention provide a convenient, durable and efficient way of marking binding posts in the field without interfering with other work in the vicinity of the marked binding posts. Moreover, the binding post markers occupy little room in a technician's tool holder, are reusable and can also be recycled, if so desired.

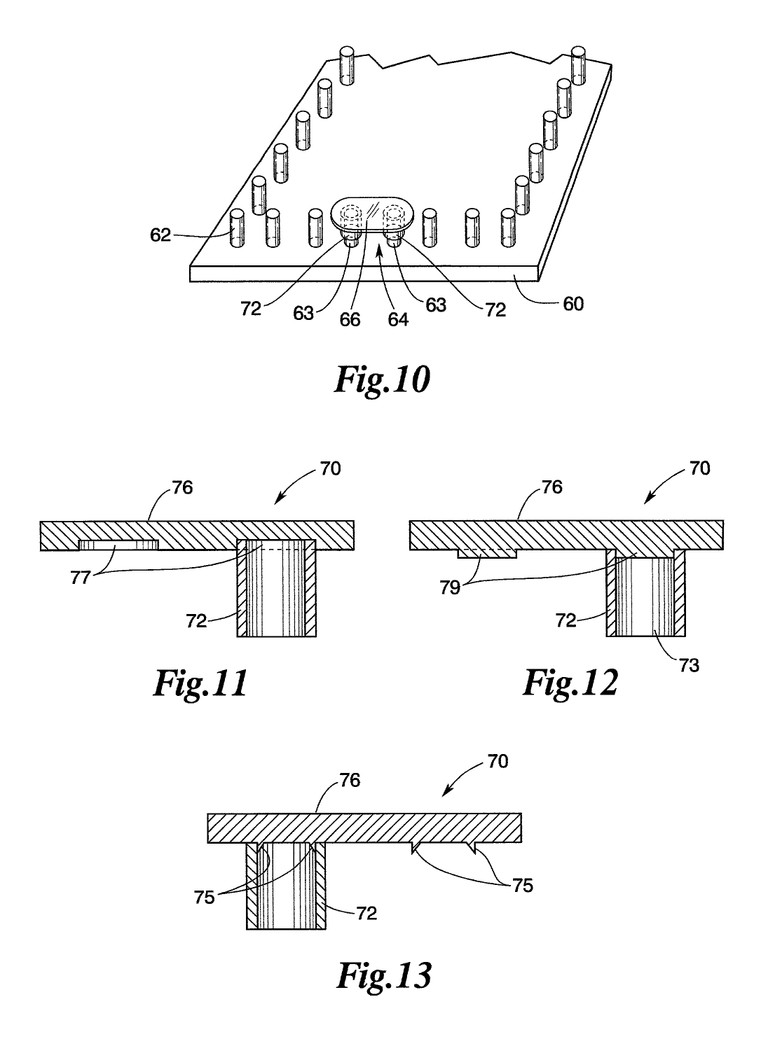

Although various embodiments of the invention have been described in reference to the binding posts 12 of a cross-connect board 10, an embodiment of the marker 64 may be used to identify two or more elongate elements 63 among a plurality of elongate elements 62 that protrude from a substrate 60, such as, for example, connection pins on a circuit board, as shown in FIG. 10. The overall size and the specific dimensions of the marker 64 may selected appropriately for the particular application.

The invention also includes a method for marking two or more pre-selected elements 63 that protrude from a substrate 60. The method comprises inserting at least a top portion of each of the pre-selected elements 63 into corresponding tubular elements 72 and interconnecting the tubular elements with a surface element 66. The method may also include marking the surface element with a mark indicative of a condition of the two pre-selected elements 63.

In addition to permanent marks 24 and 26, superficial marks may be inscribed in situ on the top surface 18 by using an appropriate marking member.

Whereas particular embodiments of the invention have been described herein for the purpose of illustrating the invention and not for the purpose of limiting the same, it will be appreciated by those of ordinary skill in the art that numerous variations of the details, materials and arrangement of parts may be made within the principle and scope of the invention without departing from the spirit invention. The preceding description, therefore, is not meant to limit the scope of the invention. Rather the scope of the invention is to be determined only by the appended claims and their equivalents.

What is claimed is:

1. A binding post marker comprising:
a flange having a top surface and a bottom surface; and
a pair of hollow legs extending from the bottom surface and sized to be received on a pair of binding posts.

2. The binding post marker of claim 1, further comprising an identification mark on the top surface of the flange, wherein the identification mark is indicative of a condition of the binding posts on which it is received.

3. The binding post marker of claim 1, wherein the identification mark includes written indicia.

4. The binding post marker of claim 1, wherein the identification mark includes a physical feature on the surface.

5. The binding post marker of claim 1, wherein the flange and the hollow legs are integrally constructed from polymeric material.

6. The binding post marker of claim 1, wherein at least one hollow leg has a hole therein sized to create a frictional fit between the hollow leg and a corresponding binding post received therein.

7. The binding post marker of claim 1, wherein at least one portion of the binding post maker has a color that is indicative of a condition of the binding posts.

8. The binding post marker of claim 1, wherein the flange is removably attached to the legs.

9. A binding post marker comprising:
a flange having a top surface and a bottom surface; and
two pairs of hollow legs extending from the bottom surface and sized to be received on two pairs of binding posts

10. The binding post marker of claim 9, wherein the two pairs of hollow legs are aligned in one row.

11. The binding post marker of claim 9, wherein the two pairs of hollow legs are aligned in two rows.

12. A binding post marker comprising at least two joinable tubes that are sized to fit respectively over a corresponding number of binding posts in a cross-connect board.

13. A device for marking two adjacent pre-selected elements belonging to an array of elongate elements protruding from a substrate, the device comprising:
means for covering separately at least a top portion of each of the two pre-selected elements;
means for interconnecting the covering means; and
indicia means on the interconnecting means.

14. The device of claim 13, wherein the interconnecting means are detachable from the covering means.

15. A method for marking two pre-selected adjacent elements belonging to an array of elongate elements protruding from a substrate, the method comprising:
inserting at least a top portion of each of the two pre-selected elements into corresponding tubular elements; and
interconnecting the tubular elements with a surface element.

16. The method of claim 15, further comprising marking the surface element with a mark indicative of a condition of the two pre-selected elements.
